(19) United States
(12) Patent Application Publication
(10) Pub. No.: US 2025/0303536 A1
(43) Pub. Date: Oct. 2, 2025

(54) SMOOTH TORQUE TOOL

(71) Applicant: MATATAKITOYO TOOL CO., LTD., Taichung City (TW)

(72) Inventor: YI-MIN WU, Taichung City (TW)

(21) Appl. No.: 18/624,138

(22) Filed: Apr. 2, 2024

(51) Int. Cl. B25B 23/142

(52) U.S. Cl. CPC B25B 23/1427

(57) ABSTRACT

A torque tool includes a hollow head and a rotating unit. The hollow head includes a wall extending around a chamber. The rotating unit includes notches cut in a periphery. The rotor is located in the chamber. An area of contact of the periphery of the rotor with the wall around the chamber in the hollow head is reduced by the notches.

### BACKGROUND OF INVENTION

### 1. Field of Invention

The present invention relates to a torque tool and, more particularly, to a smooth torque tool.

### 2. Related Prior Art

Referring to FIG. 5, a torque tool 90 includes a tubular handle 91, a pin 92, a hollow head 93, a rod 95 and a rotating unit 97 and an adjustment mechanism 86. The hollow head 93 is separated from the rod 95. The hollow head 93 includes a tubular portion 94 for receiving the tubular handle 91 so that the hollow head 93 is not pivotable relative to the tubular handle 91. Hence the hollow head 93 does not hit or damage the tubular handle 91.

The rod 95 is partially inserted in the tubular handle 91. The pin 92 is inserted in the tubular portion 94 and the tubular handle 91, thereby pivotally connecting the hollow head 93 to the tubular handle 91. The rod 95 includes a rounded end 96 extending in the hollow head 93 from the tubular handle 91. The rod 95 includes another end (not numbered) in contact with the adjustment mechanism 86.

The rotating unit 97 includes a lever 98 instead of the combination of the toothed wheel with the pawls. The lever 98 includes a recess 99 for receiving the rounded end 96. The tongue 88 is connected to the rotating unit 97. The tongue 88 is engageable with a nut or a head of a screw via a socket.

A force is exerted on the tubular handle 91 to provide a torque for driving the nut or screw via the tongue 88.

As the torque reaches an adjustable value, the rod 95 shakes off the adjustment mechanism 86 and hits the tubular handle 91 to provide a sound. The sound draws attention from a user of the torque tool 90 that the torque has reached the adjustable value.

However, there is friction between a concave face of the recess 99 wears against a convex face of the rounded end 96. This friction inevitably causes the recess 99 and the rounded end 96 to wear away each other. Moreover, the friction comprises precision in pivoting the rod 95 relative to the adjustment unit 86 when the adjustable value is reached.

The present invention is therefore intended to obviate or at least alleviate the problems encountered in the prior art.

The present invention is therefore intended to obviate or at least alleviate the problems encountered in the prior art.

### SUMMARY OF INVENTION

It is the primary objective of the present invention to provide a smooth torque tool.

To achieve the foregoing objective, the torque tool includes a hollow head and a rotating unit. The hollow head includes a wall extending around a chamber. The rotating unit includes notches cut in a periphery. The rotor is located in the chamber. An area of contact of the periphery of the rotor with the wall around the chamber in the hollow head is reduced by the notches.

In another aspect, the hollow head includes a tubular section in communication with the chamber. The rotating unit includes a lever extending from the periphery of the rotor toward the tubular section.

In another aspect, the torque tool further includes a tubular handle inserted in the tubular section.

In another aspect, the torque tool further includes a rod with a first section extending in the tubular handle and a second section extending in the chamber from the tubular handle. The second section of the rod is operatively connected to the lever.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a partial, perspective view of a torque tool according to the preferred embodiment of the present invention;

FIG. 2 is an exploded view of the torque tool shown in FIG. 1;

FIG. 3 is a partial, cross-sectional view of the torque tool shown in FIG. 1;

FIG. 4 is a partial, cross-sectional view of the torque tool shown in FIG. 3; and

FIG. 5 is a partial, cross-sectional view of another conventional torque tool.

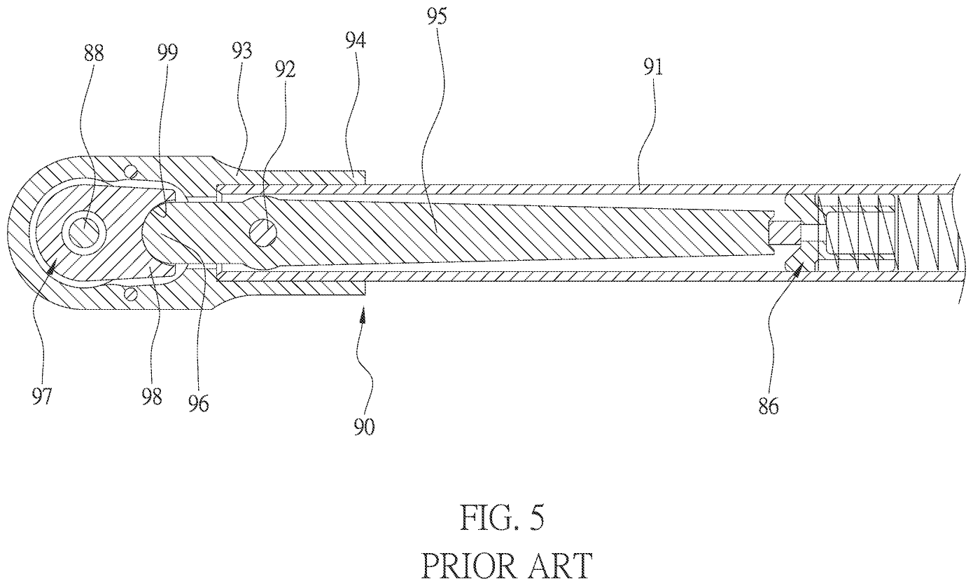

### DETAILED DESCRIPTION OF PREFERRED EMBODIMENT

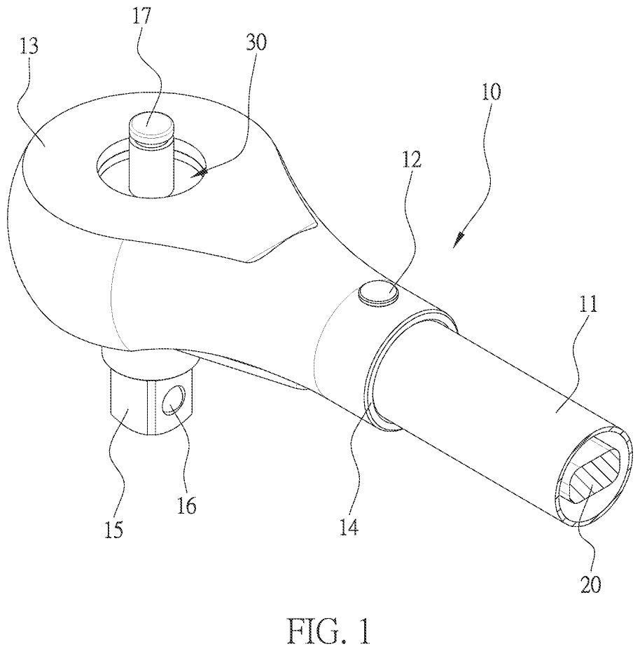

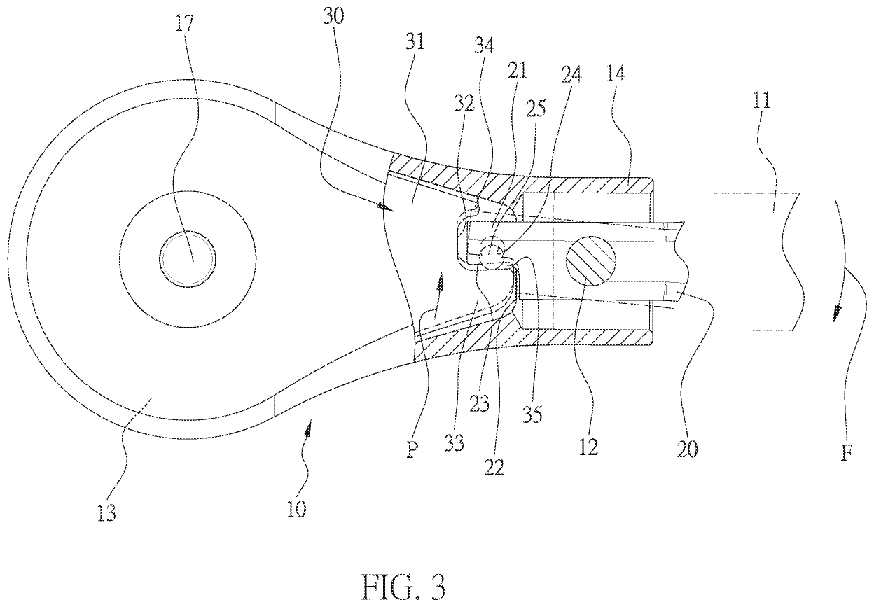

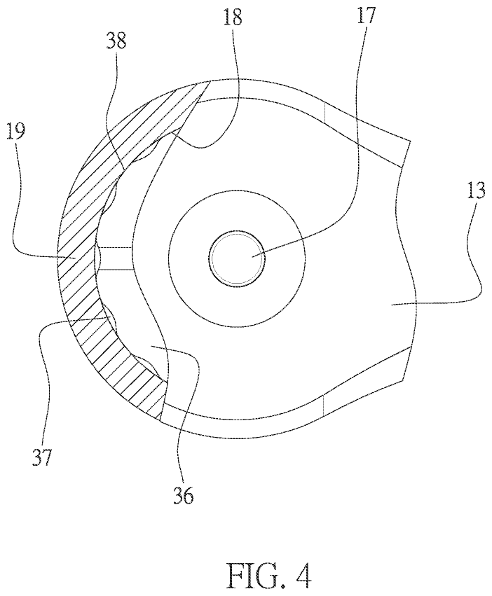

Referring to FIGS. 1 through 4, a torque tool 10 includes a tubular handle 11, a pivot 12, a hollow head 13, a rod 20 and a rotating unit 30 according to the preferred embodiment of the present invention.

The tubular handle 11 receives an adjustment unit (not shown). The adjustment unit is operable to adjust a limit of torque to be exerted via the torque tool 10.

The hollow head 13 includes a tubular portion 14 extending from the periphery of an annular portion (not numbered). The tubular portion 14 is in communication with the annular portion. The hollow head 13 includes a chamber 18.

The tubular handle 11 includes a first terminal section inserted in the tubular portion 14. The pivot 12 is inserted in the tubular portion 14 and the tubular handle 11, thereby connecting the hollow head 13 to the tubular handle 11. The tubular handle 11 is not pivotable relative to the hollow head 13, thereby preventing them from wearing away each other. The tubular handle 11 includes a second terminal section for receiving the adjustment mechanism.

The pivot 12 is preferably a rivet. However, the pivot 12 can be replaced with a pin, a screw, a combination of a screw with a nut, or any other proper devices.

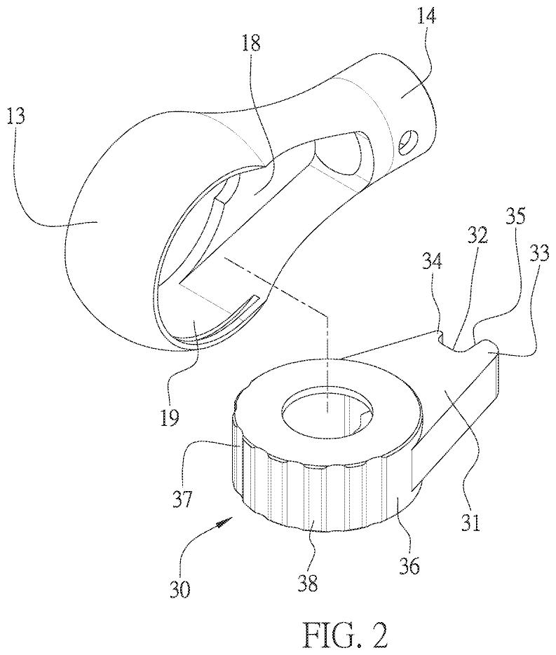

Referring to FIGS. 1 and 2, the rod 20 is inserted in the tubular handle 11. A first terminal section of the rod 20 is inserted in the first terminal section of the tubular handle 11. The pivot 12 is inserted in first terminal section of the rod 20.

A second terminal section of the rod 20 is inserted in the second terminal section of the tubular handle 11. The second terminal section of the rod 20 is in contact with the adjustment mechanism.

The first terminal section of the rod 20 is inserted in the hollow head 13. The first terminal section of the rod 20 is formed with an extensive portion 21, a concave portion 22 and a recess 24. The extensive portion 21 is located next to the concave portion 22. The recess 24 is made in a side 23 of the extensive portion 21 which faces the concave portion 22. The recess 24 is preferably a semi-spherical recess for receiving an abrasion-resistant element 25.

The abrasion-resistant element 25 includes a first portion inserted in the recess 24 and a second portion located out of the recess 24. The first portion of the abrasion-resistant element 25 is at least marginally larger than the second portion of the abrasion-resistant element 25 so that abrasion-resistant element 25 is allowed to roll relative to the rod 20 without any risk of leaving the rod 20. The abrasion-resistant element 25 can be a roller or a ball. The abrasion-resistant element 25 is made of a hard material such as CNS (or JIS) SUJ2 bearing steel or any other proper material.

The rotating unit 30 includes a rotor 36, a lever 31, a square tongue 15, a detent 16 and a button 17. The rotor 36 includes notches 37 cut in the periphery and teeth 38 formed on the periphery. The notches 37 are alternately arranged with the teeth 38. The lever 31 also extends from the periphery of the rotor 36.

The square tongue 15 extends from a lower face of the rotor 36. The detent 16 is preferably a ball including a first portion movable in a transverse bore (not numbered) made in the square tongue 15 and a second portion movable out of the transverse bore of the square tongue 15. The button 17 includes a lower section movable in a longitudinal bore made in the square tongue 15 and an upper section extensible from the longitudinal bore of the square tongue 15.

The rotating unit 30 is located in the chamber 18 of the hollow head 13. In specific, the rotor 36 is located in the annular portion of the hollow head 13. The lever 31 extends toward the tubular section 14. The teeth 38 of the rotor 36 are in contact with a wall 19 of the chamber 18. The area of the contact of the periphery of the rotor 36 with the wall 19 of the chamber 18 of the hollow head 13 is reduced by the notches 37. Accordingly, during pivoting of the rotating unit 30 relative to the hollow head 13, friction between the periphery of the rotor 36 and the wall 19 of the chamber 18 of the hollow head 13 is reduced. Thus, the pivoting of the rotating unit 30 in the hollow head 13 is smooth.

The lever 31 preferably includes a cutout 32 between a long protuberance 33 and a short protuberance 34. The long protuberance 33 and the short protuberance 34 extend from a free end of the lever 31, in parallel to each other. The long protuberance 33 includes an internal side 35 facing the short protuberance 34 and an external side (not numbered) opposite to the internal side 35.

The lever 31 is pivotable in the hollow head 13. The long protuberance 33 of the lever 31 is located in the concave portion 22 of the rod 20. The cutout 32 of the lever 31 receives the extensive portion 21 of the rod 20 so that the extensive portion 21 is located between the long protuberance 33 and the short protuberance 34. The abrasion-resistant element 25 is in contact with the extensive portion 21 at an end and in contact with the long protuberance 33 at another end.

A force Fis exerted on the tubular handle 11 to rotate the tubular handle 11 and the hollow head 13. Thus, the torque tool 10 is used to provide a torque for tightening or slackening a workpiece such as a nut or a screw. The workpiece exerts a counter force P via the rotating unit 30. The counter force P is larger than the force F. The long protuberance 33 is moved to a new position shown in phantom lines from an original position shown in solid lines. The short protuberance 34 does not prevent the rod 20 from hitting the tubular handle 11 to make a sound for warning of the torque reaching an adjustable limit.

Advantageously, the area of the contact of the abrasion-resistant element 25 with the long protuberance 33 is very small. Thus, damage of the elements of the torque tool 10 is minimized, and so is the waste of energy for operating the torque tool 10.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A torque tool comprising:
a hollow head comprising a chamber and a wall extending around the chamber; and
a rotating unit comprising a rotor formed with a periphery and notches cut in the periphery, wherein the rotor is located in the chamber, wherein an area of contact of the periphery of the rotor with the wall around the chamber in the hollow head is reduced by the notches.

2. The torque tool according to claim 1, wherein the hollow head comprises a tubular section in communication with the chamber, wherein the rotating unit comprises a lever extending from the periphery of the rotor toward the tubular section.

3. The torque tool according to claim 2, further comprising a tubular handle inserted in the tubular section.

4. The torque tool according to claim 3, further comprising a rod with a first section extending in the tubular handle and a second section extending in the chamber from the tubular handle, wherein the second section of the rod is operatively connected to the lever.
